(19) United States
(12) Patent Application Publication
(10) Pub. No.: US 2021/0130051 A1
(43) Pub. Date: May 6, 2021

(54) LID FOR A DRINKING VESSEL WITH INTEGRATED VENTING MECHANISM

(71) Applicant: Runway Blue, LLC, Alpine, UT (US)

(72) Inventors: David O. MEYERS, Layton, UT (US); John R. OMDAHL, II, Lindon, UT (US); Jim Allen COLBY, Highland, UT (US)

(21) Appl. No.: 17/087,237

(22) Filed: Nov. 2, 2020

Related U.S. Application Data
(60) Provisional application No. 62/930,914, filed on Nov. 5, 2019.

(51) Int. Cl. B65D 47/32; B65D 47/08; B65D 43/02

(52) U.S. Cl. CPC B65D 47/32; B65D 47/0871; B65D 2251/1066; B65D 2205/02; B65D 2251/1033; B65D 43/0229

(57) ABSTRACT

A lid for a drinking vessel, including a lid base, a moveable arm, and an actuator. The lid base defines a vent opening therethrough. The movable arm is coupled to the lid base. The actuator is accessible from an exterior of the lid base. The movable arm is movable between a sealed position, in which the vent opening is sealed, and a venting position, in which the vent opening is not sealed. The movable arm is biased toward the sealed position. The actuator is movable between a first position and a second position. The movable arm moves from the sealed position to the venting position in response to the actuator moving from the first position to the second position.

### CROSS-REFERENCE TO RELATED APPLICATIONS

This application claims the benefit of U.S. Provisional Patent Application No. 62/930,914, filed Nov. 5, 2019, which is incorporated herein in its entirety by reference thereto.

### FIELD

This disclosure generally relates to drinking vessels for beverages. More specifically, some embodiments relate to vessels with venting mechanisms.

### BACKGROUND

Drinking vessels for beverages may include a container that is sealed relative to an atmosphere outside of the drinking vessel. A pressure difference may develop between an interior of the container and the atmosphere outside of the drinking vessel.

### SUMMARY

Some embodiments described herein are directed to a lid for a drinking vessel, including a lid base, a moveable arm, and an actuator. The lid base defines a vent opening therethrough. The movable arm is coupled to the lid base. The actuator is accessible from an exterior of the lid base. The movable arm is movable between a sealed position, in which the vent opening is sealed, and a venting position, in which the vent opening is not sealed. The movable arm is biased toward the sealed position. The actuator is movable between a first position and a second position. The movable arm moves from the sealed position to the venting position in response to the actuator moving from the first position to the second position.

Some embodiments described herein are directed to a lid for a drinking vessel, including a lid base, a vent seal, and a cap. The lid base defines a vent opening therethrough. The vent sealing member is movably coupled to the lid base and movable between a sealed position, in which the vent sealing member seals the vent opening, and a venting position, in which the vent sealing member does not seal the vent opening. The cap is coupled to the lid base and movable between a closed position and an open position. In response to the cap moving from the closed position to the open position, the vent sealing member moves from the sealed position to the venting position. The cap is movable relative to the vent seal.

Some embodiments described herein are directed to a method for venting a drinking vessel, including pivoting a movable arm disposed within a lid for a drinking vessel in a first rotational direction about an axis and pivoting the movable arm in a second rotational direction about the axis. Pivoting the movable arm in the first rotational direction causes a vent opening of the lid base to be unsealed. Pivoting the movable arm in the second rotational direction causes the vent opening of the lid to be unsealed. The movable arm is biased in the second rotational direction.

Some embodiments described herein are directed to a method for venting a drinking vessel, including moving an actuator accessible from an exterior of a lid base from a first position to a second position and moving the actuator from the second position to the first position. Moving the actuator from the first position to the second position causes a vent opening of the lid base to be unsealed. Moving the actuator from the second position to the first position causes the vent opening of the lid base to be sealed. A drinking passageway of the lid base remains sealed while the vent opening is unsealed.

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows an upper front perspective view of a drinking vessel.

FIG. 2 shows an upper rear perspective view of the drinking vessel of FIG. 1, with the handle in an upright position.

FIG. 3 shows a front view of the drinking vessel of FIG. 1.

FIG. 4 shows an upper front perspective view of the drinking vessel of FIG. 1, with the cap in an open position.

FIG. 5 shows an exploded upper rear perspective view of a portion of the drinking vessel of FIG. 1.

FIG. 6 shows an exploded lower front perspective view of a portion of the drinking vessel of FIG. 1.

FIG. 7 shows a sectional upper perspective view of a portion of the drinking vessel of FIG. 1 in an unlocked, sealed configuration, taken at the position of line VII-VII′ of FIG. 3.

FIG. 8 shows a vertical sectional view of a portion of the drinking vessel of FIG. 1 in an unlocked, sealed configuration, taken at the position of line VIII-VIII′ of FIG. 3.

FIG. 9 shows an enlarged view of a portion of FIG. 8.

FIG. 10 shows a vertical sectional view of a portion of the drinking vessel of FIG. 1 in a venting configuration, taken at the position of line X-X′ of FIG. 3.

FIG. 11 shows an enlarged view of a portion of FIG. 10.

FIG. 12 shows a vertical sectional view of a portion of the drinking vessel of FIG. 1, with the cap in an open position, taken at the position of line X-X′ of FIG. 3.

FIG. 13 shows an enlarged view of a portion of FIG. 12.

FIG. 14 shows a sectional upper perspective view of a portion of the drinking vessel of FIG. 1 in a locked configuration, taken at the position of line VII-VII′ of FIG. 3.

FIG. 15 shows a vertical sectional view of a portion of the drinking vessel of FIG. 1 in a locked configuration, taken at the position of line VIII-VIII′ of FIG. 3.

FIG. 16 shows an enlarged view of a portion of FIG. 15.

FIG. 17 shows an upper rear perspective view of a moveable arm of the drinking vessel of FIG. 1.

FIG. 18 shows an upper front perspective view of a moveable arm of the drinking vessel of FIG. 1.

FIG. 19 shows an upper rear perspective view of an actuator of the drinking vessel of FIG. 1.

FIG. 20 shows an upper front perspective view of an actuator of the drinking vessel of FIG. 1.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein comport with standards used by those experienced or skilled in the art to most effectively convey the substance of their work to others skilled in the art. In some instances, well-known methods, procedures, components, and elements have not been described in detail to avoid unnecessarily obscuring aspects of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, this disclosure has been prepared such that when a particular feature, structure, or characteristic is described in connection with an embodiment, it is within the knowledge of one skilled in the art to apply such feature, structure, or characteristic in connection with other embodiments whether or not explicitly described.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

People use reusable containers to carry a variety of beverages. It is often desirable for a container to be air-tight when a user is not drinking from it so that the beverage being carried will not leak on a user or a user's belongings. An air-tight container may be achieved by sealing the drinking passageway of the container. But over time, pressure may build up inside an air-tight container, for example when the container is used to carry a hot beverage. When a user later opens the container to drink from it, for example by unsealing the drinking passageway, the built-up pressure may cause air or liquid to be released via the drinking passageway. For example, if the drinking passageway is connected to a straw that extends into a liquid within the container, liquid may be forced up the straw and out the drinking passageway in order to relieve the built-up pressure.

Some reusable beverage containers may include an air vent to allow a user to more easily drink through a drinking passageway. When the drinking passageway is sealed, the air vent may also be sealed, in order to maintain an air-tight seal when the container is not in use.

Some embodiments of the present disclosure provide a lid for a beverage container that can be used to relieve the pressure inside a container by moving an actuator (e.g., pressing a button) accessible from the exterior of the lid. When the user presses the button, a vent opening in the lid is unsealed, allowing a controlled pressure release. When the user stops pressing the button, the vent opening is resealed. Unsealing and resealing the vent opening using the button in this way can occur independently of whether the drinking spout is sealed or unsealed. Thus, the vent opening can be unsealed and resealed while the drinking passageway remains sealed. For example, a user may press the button to unseal the vent opening before unsealing the drinking passageway to take a drink. In this way, the user avoids venting the container through the drinking passageway.

The actuator may be locked so that the vent opening is not accidently unsealed.

In some embodiments, the lid may also include a cap that seals the drinking passageway of the lid. The lid may include a lock so that the cap cannot be opened when in a locked configuration. In the closed position, the drinking passageway may be sealed. When a user moves the cap from the closed position to the open position, the vent seal moves automatically from the sealed position to the venting position, and is maintained in the venting position while the cap is open.

Some embodiments may include both an actuator to selectively vent the beverage container, as mentioned above and described in more detail below, and a cap that when opened automatically unseals the vent opening, as mentioned above and described in more detail below. But both are independently beneficial, and some embodiments may include one and not the other.

These and other embodiments are discussed below in more detail with reference to the figures.

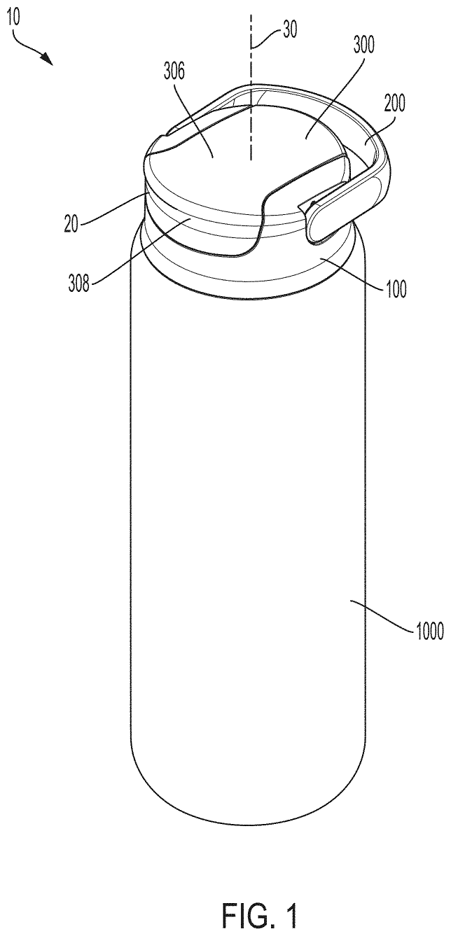

FIGS. 1-4 show a drinking vessel 10 according to some embodiments. Drinking vessel 10 may include a container 1000 and a lid 20 for container 1000. Lid 20 may include multiple components, including a lid base 100, a handle 200, a cap 300, and an actuator 700.

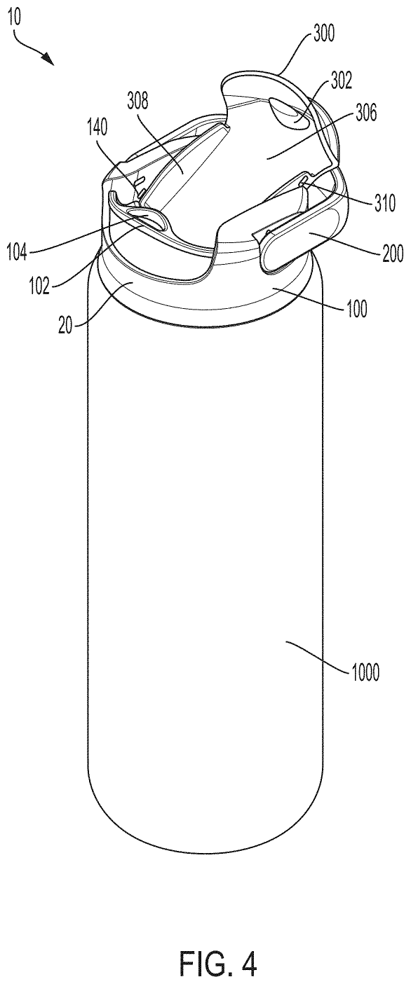

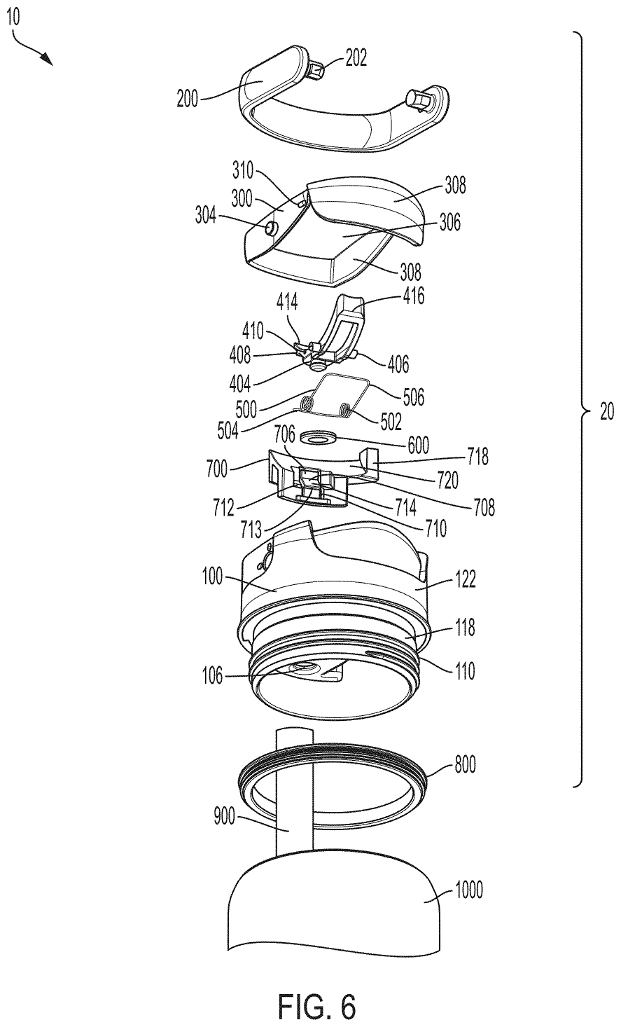

Lid base 100 may include a drinking passageway 104 (shown, for example, in FIG. 4) through which a user can drink a beverage contained within container 1000 when lid 20 is assembled with container 1000. Lid base 100 may also include a vent opening 106 (shown, for example, in FIG. 6). Vent opening 106 may allow for fluid (e.g., gas, such as air) communication between an interior 1006 of container 1000 and an atmosphere outside of drinking vessel 10 when vent opening 106 is unsealed.

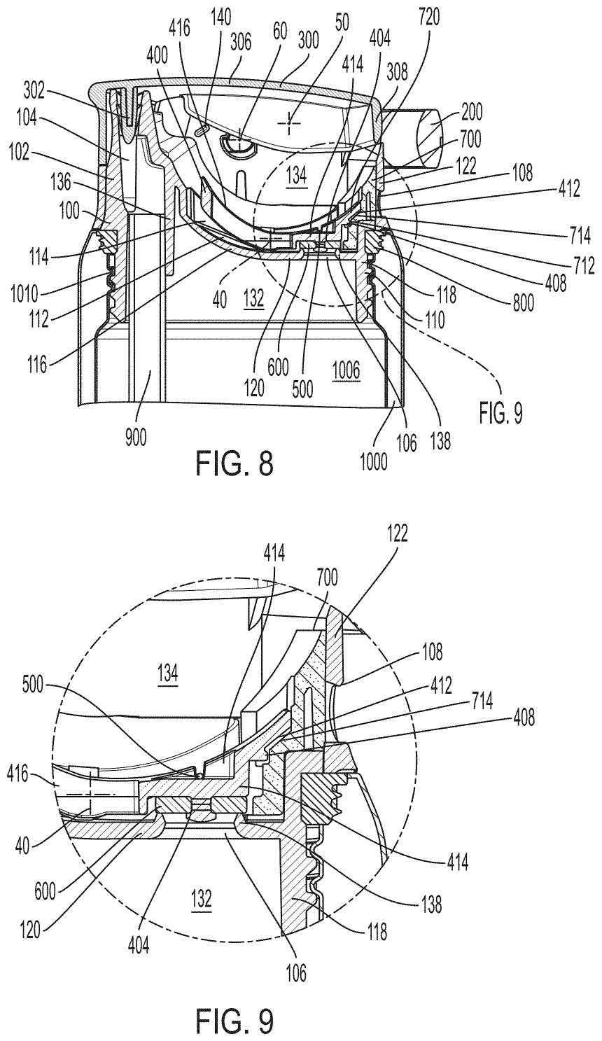

Lid 20 when assembled with container 1000 can create an airtight seal. For example, drinking passageway 104 and vent opening 106 may be the only openings extending though lid base 100 to container 1000, and drinking passageway 104 and vent opening 106 may be sealed in some configurations. For example, drinking passageway 104 may be sealed by a sealing member 302 of cap 300 when cap 300 is in a closed position (as shown, for example, in FIG. 1) and vent opening 106 may be sealed by a vent sealing member 600 (as shown, for example, in FIG. 8, to be discussed in greater detail below). If drinking vessel 10 is maintained in the sealed configuration for a sufficient period of time, a pressure difference can develop between the interior 1006 and exterior of container 1000. The pressure difference may be caused, for example, by a hot beverage within container 1000 or a change in elevation.

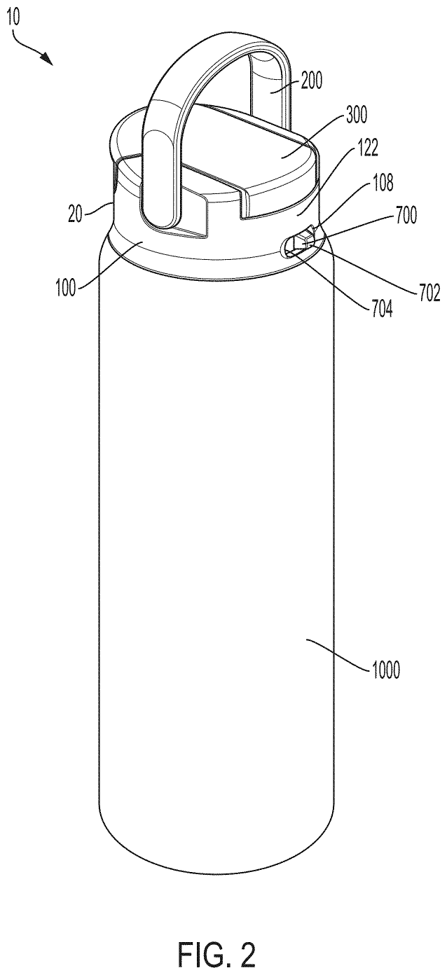

As shown in FIG. 2, actuator 700 may be accessible from the exterior of lid base 100. Actuator 700 may be or include, for example, a button 702 (as shown in FIG. 2), a switch, a lever, or other suitable mechanical mechanism. Actuator 700 may be moveable between a first position and a second position in order to vent container 1000. In embodiments where actuator 700 is or includes a button, for example, actuator 700 may be moveable from the first position to the second position, for example, by pressing actuator 700, and from the second position to the first position, for example, by releasing actuator 700.

When a user moves actuator 700 from the first position to the second position, vent opening 106 in lid base 100 is unsealed, thereby allowing fluid communication between an interior 1006 of container 1000 and an atmosphere outside of drinking vessel 10. In this way, the user can relieve pressure buildup inside container 1000 (or otherwise equalize pressure between an interior 1006 of container 1000 and an atmosphere outside of drinking vessel 10) by venting container 1000 through vent opening 106. For example, a user may move actuator 700 from the first position to the second position to unseal vent opening 106 before unsealing drinking passageway 104 to take a drink. When a user moves actuator 700 from the second position to the first position, vent opening 106 is resealed.

In some embodiments, actuator 700 is also moveable relative to lid base 100 to prevent accidental venting of container 1000 and/or opening of cap 300. A user may move actuator 700 to a locked position, for example, by engaging a portion of actuator 700 and sliding actuator 700 (e.g., in a counter-clockwise direction about a central axis 30 of lid 20, viewed from the top of lid 20). In some embodiments, a user may engage button 702 to move actuator 700 to or from the locked position. In other embodiments, a user may engage a different part of actuator 700 to move actuator 700 to or from the locked position. When actuator 700 is in the locked position, actuator 700 is inhibited from moving from the first position to the second position to unseal vent opening 106. Actuator 700 may include an indicator 704. For example, indicator 704 might be an area of contrasting color (e.g., a red area) or another graphical feature, such as an image. When actuator 700 is in the locked position (as shown in FIG. 2), indicator 704 is visible to a user, indicating that actuator 700 is in the locked position. When actuator 700 is in the unlocked position, indicator 704 is hidden behind upper side wall 122 of lid base 100, indicating that container 1000 can be vented by actuating actuator 700.

Actuator 700 may include an indentation 716 on an outer surface, and lid base 100 may include a bump 142 (not shown) on an interior surface of upper side wall 122. Bump 142 may interact with (e.g., be received by) indentation 716 to help maintain actuator 700 in the locked or unlocked position, as the case may be, and may provide a user with feedback during use. For example, as a user moves actuator 700 to a locked position, the user may hear a click or feel tactile feedback when actuator 700 reaches the locked position (e.g., resulting from bump 142 being received by indentation 716). In some embodiments, the positions of bump 142 and indentation 716 may be reversed (i.e., such that actuator 700 includes a bump and lid base 100 includes a corresponding indentation).

Cap 300 may be moveable relative to lid base 100 between a closed position (as shown in FIGS. 1-3) and an open position (as shown in FIG. 4). When cap 300 is in the closed position, drinking passageway 104 is sealed by a sealing member 302 of cap 300. For example, sealing member 302 of cap 300 may extend down into spout 102 and press against an inner surface of drinking passageway 104 to seal drinking passageway 104. Sealing member 302 may be formed as a plug or gasket and may be integrally formed as part of cap 300 or may be a separate component attached to cap 300. Sealing member 302 may be formed of a food-grade material suitable to create a seal between spout 102 and cap 300. When cap 300 is in an open position, sealing member 302 of cap 300 does not seal drinking passageway 104 (e.g., so that a user may drink from drinking vessel 10 through drinking passageway 104). As explained in more detail elsewhere herein, in some embodiments, when a user moves cap 300 from the closed position to the open position, vent opening 106 is automatically unsealed, thereby allowing fluid communication between an interior 1006 of container 1000 and an atmosphere outside of drinking vessel 10. In some embodiments, vent opening 106 remains unsealed while cap 300 is in the open position. In some embodiments, cap 300 is inhibited from opening when drinking vessel 10 is in a locked configuration.

Cap 300 may include a top panel 306 and a wall 308. When cap 300 is in the closed position (for example, as shown in FIG. 1), all or part of cap wall 308 may form a portion of the exterior of lid 20. For example, as shown in FIG. 1, when cap 300 is in the closed position, a front and rear portion of cap wall 308 form a portion of the exterior of lid 20, while a left and right portion of cap wall 308 are internal to lid 20. When cap 300 is in the open position (for example, as shown in FIG. 4), top panel 306 and wall 308 of cap 300 may hide internal mechanisms (such as a movable arm, biasing member, vent sealing member, and vent opening, as discussed in more detail elsewhere herein) from a user's view.

Handle 200 may be moveable relative to lid base 100. For example, a user may pivot handle 200 from a horizontal storage position (as shown in FIG. 1) to an upright position (as shown in FIG. 2) to enable easy carrying of drinking vessel 10.

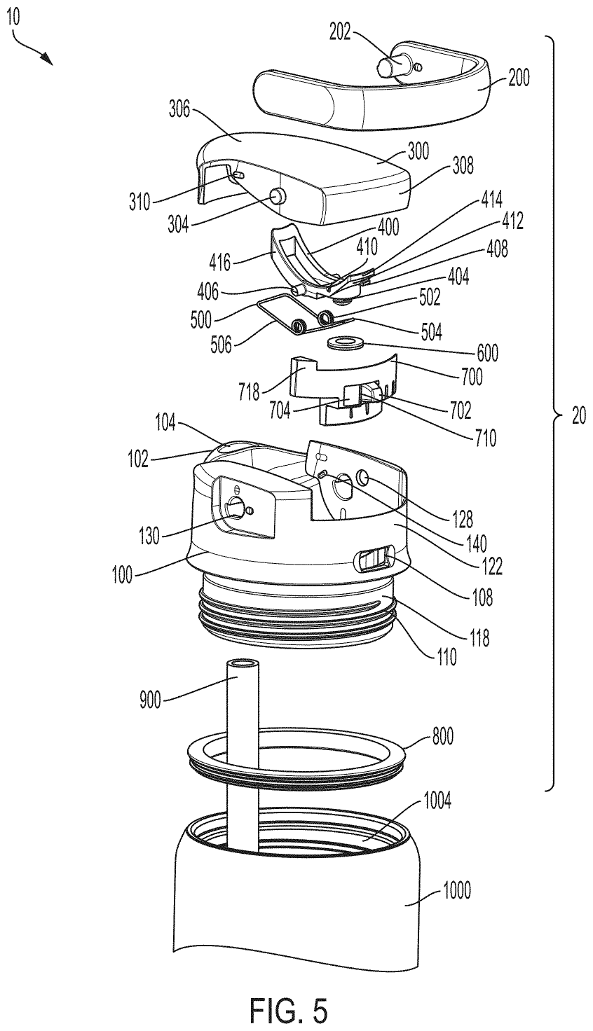

FIGS. 5-6 show exploded views of drinking vessel 10 according to some embodiments. As shown, lid 20 includes lid base 100, handle 200, cap 300, a moveable arm 400, a biasing member 500, a vent sealing member 600, actuator 700, and a lid sealing member 800. Drinking vessel 10 may also include a straw 900 and container 1000.

Lid base 100 may define a spout 102 through which drinking passageway 104 extends. An inner passageway of straw 900 may be in fluid communication with drinking passageway 104. Straw 900 may extend away from a bottom side of lid 20 such that when lid 20 is attached to container 1000, straw 900 extends into interior 1006 of container 1000 and opens at or near a bottom of interior 1006 of container 1000. In an upright orientation, a lower end of straw 900 could be submerged in liquid contained within interior 1006 of container 1000. A user may suck on drinking passageway 104, which suction will be transmitted through drinking passageway 104, through straw 900, and into liquid contained within interior 1006 of container 1000. This will cause such liquid to be drawn up through straw 900 and drinking passageway 104 into the user's mouth for consumption. Straw 900 may be integrally formed as part of lid base 100 or may be a removable component.

Lid base 100 may include attachment mechanism 110 on lower side wall 118. Container 1000 may include a corresponding attachment mechanism 1010 near an upper edge of the container, configured to engage with attachment mechanism 110 to removably attach container 1000 to lid 20. Attachment mechanisms 110 and 1010 may be threaded connectors (as shown in FIG. 5), friction fit connectors, snap-fit connectors, or any other suitable releasable attachment mechanism. The attachment of lid base 100 to container 1000 is not limited to the arrangement shown in the figures. For example, in some embodiments, lid base 100 may attach over container 1000 rather than inside container 1000.

When assembled with container 1000, lid sealing member 800 may be pressed between lid base 100 and an inner surface 1004 of container 1000, to create a seal between lid 20 and container 1000. Lid sealing member 800 may be a removable component (e.g., a removable gasket), or may be an integrally-formed part of lid base 100 or container 1000.

Moveable arm 400 may be positioned at least partially within a recess 112 of lid base 100, and vent sealing member 600 may be positioned at least partially between moveable arm 400 and lid base 100. When assembled with moveable arm 400 and lid base 100, vent sealing member 600 may move with movable arm 400 such that sealing member 600 may be selectively pressed between moveable arm 400 and lid base 100 to create a seal between them when moveable arm 400 is in certain positions. In this way, vent sealing member 600 may selectively cover and seal vent opening 106 of lid base 100.

Vent sealing member 600 may have any shape and configuration sufficient to seal vent opening 106. For example, vent sealing member 600 may have an annular shape, as illustrated in FIG. 5. Vent sealing member 600 may be received within a channel 404 of movable arm 400 (e.g., about a post of movable arm 400). Vent sealing member 600 may move along with moveable arm 400. In some embodiments, vent sealing member 600 is integrally formed as part of moveable arm 400. In some embodiments, vent sealing member 600 may be a removable component (e.g., a removable gasket).

Actuator 700 may be positioned at least partially within lid base 100 and may be accessible from the exterior of lid base 100. For example, as shown in FIG. 2, a portion of actuator 700 may protrude through an opening 108 in upper side wall 122 of lid base 100. When actuator 700 moves between the first position and second position as discussed above (e.g., when actuator 700 is pressed, as a button), actuator 700 may engage moveable arm 400 and cause it to move between a sealed position, in which vent opening 106 is sealed, and a venting position, in which vent opening 106 is not sealed. Actuator 700 may be movable relative to moveable arm 400 from an unlocked position to a locked position, and vice versa, as discussed more fully below.

Biasing member 500 may extend between movable arm 400 and lid base 100. In some embodiments, biasing member 500 biases movable arm 400 toward the sealed position.

Container 1000 may be any type of container. Container 1000 may be cylindrical (as shown, for example, in FIGS. 1-5) or have another exterior or interior shape. In some embodiments, container 1000 may be double-walled to enhance thermal insulative properties of container 1000. In some embodiments, an area between container 1000′s double walls may be hermetically sealed and may form at least a partial vacuum. In some embodiments, container 1000 may be formed of stainless steel. In some embodiments, container 1000 may be formed of another food-grade material, such as a food-grade plastic (e.g., polypropylene, copolyester, the copolymer sold as Eastman Tritan, high-density polyethylene (HDPE), polyoxymethylene (POM), or acrylonitrile butadiene styrene (ABS)), glass, or another metal (e.g., steel, aluminum, copper, or titanium).

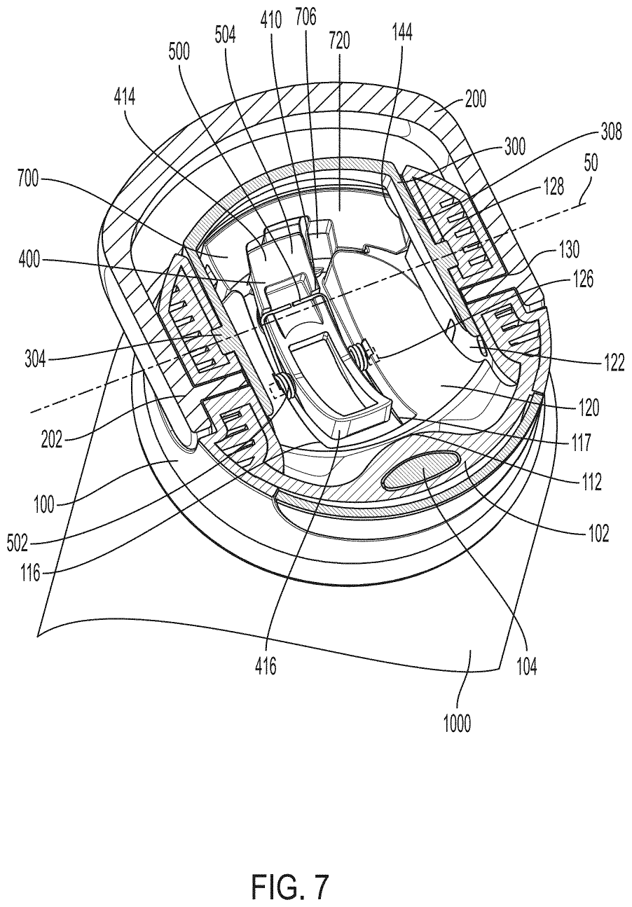

FIGS. 7-16 show detailed views of an embodiment for implementing some features as have been described. The specific structures and mechanisms shown and described (here and anywhere else in this document) may not be the only way to accomplish the functions described, and each element may be implemented using other shapes, structures, and appearances than specifically shown and described.

FIGS. 7-16 are cross-sectional views showing relative positions of certain components of lid 20 during operation. As mentioned above, during operation a user may move actuator 700 from a first position to a second position (e.g., by pressing actuator 700 like a button) in order to vent container 1000. Actuator 700 may be biased to return to (or remain in) the first (unpressed, sealed) position in the absence of an applied force. Alternatively or additionally, in some embodiments, moving cap 300 from the closed position to the open position (e.g., to make drinking passageway 104 accessible to a user) may automatically vent container 1000.

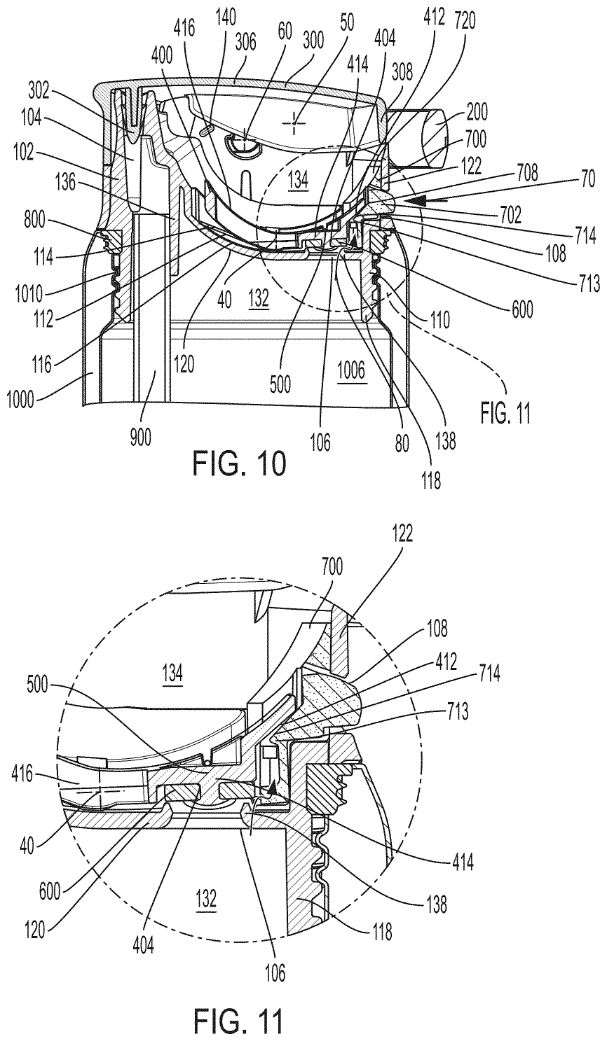

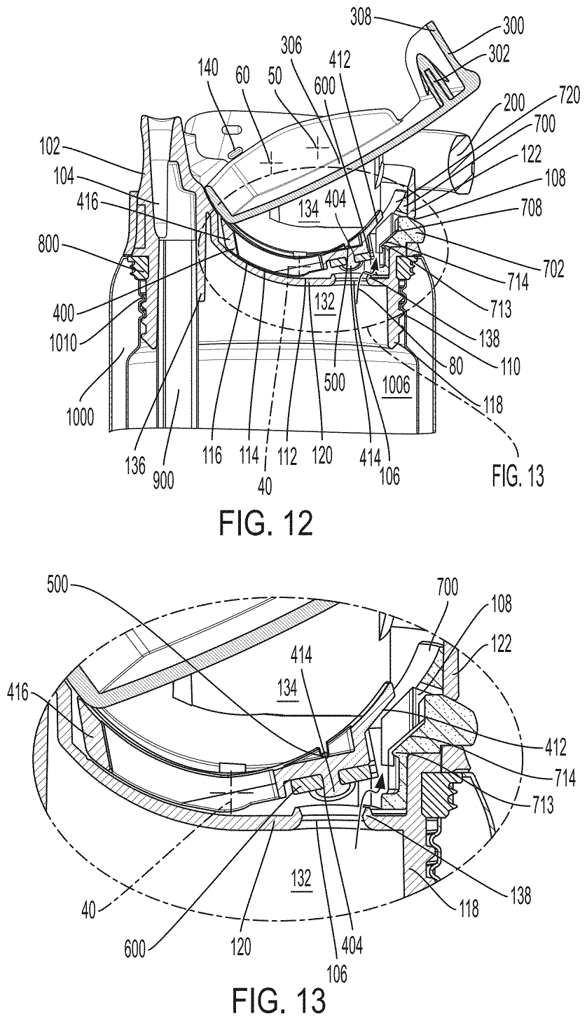

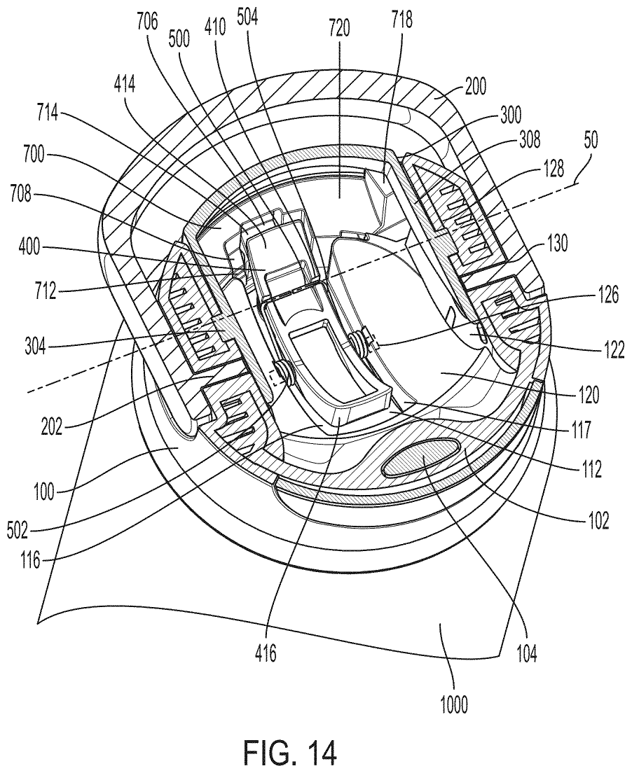

In some embodiments, a user may also place lid 20 in a locked configuration in which actuator 700 is inhibited from moving from the first position to the second position and/or cap 300 is prevented from moving to the open position. FIGS. 7-16 show relative positions of portions of lid base 100, moveable arm 400, actuator 700, and other components of lid 20 when lid 20 is in four operational states: an unlocked configuration with actuator 700 in the first position (FIGS. 7-9), an unlocked configuration with actuator 700 in the second position (FIGS. 10 and 11), an unlocked configuration with cap 300 in the open position (FIGS. 12 and 13), and a locked configuration in which actuator 700 is inhibited from moving from the first position to the second position and cap 300 is prevented from moving to the open position (FIG. 14-16).

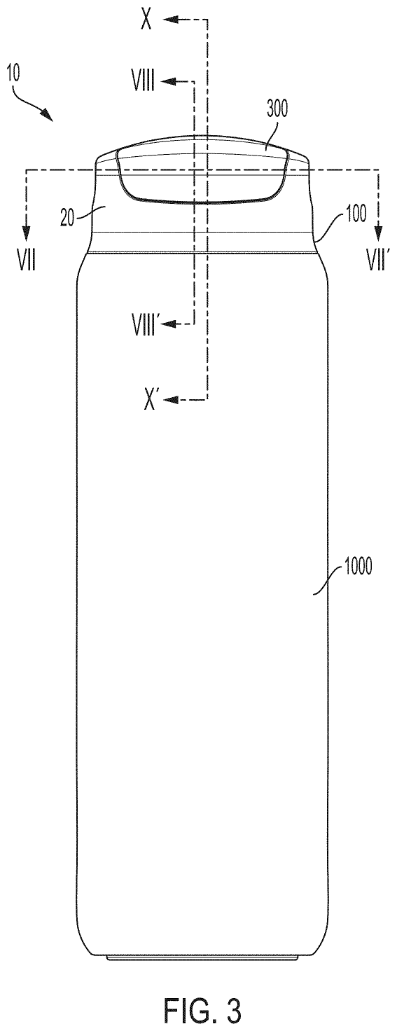

FIGS. 7-9 show an assembled cross-sectional view of an upper portion of drinking vessel 10 when lid 20 is in an unlocked configuration with actuator 700 in the first position. The section in FIG. 7 is taken horizontally at the position of line VII-VII′ of FIG. 3 offset from the top of lid 20. The section in FIGS. 8 and 9 is taken vertically at the position of line VIII-VIII′ of FIG. 3 offset to the right of the center of lid 20.

As shown, for example, in FIG. 8, assembled drinking vessel 10 includes lid 20, straw 900, and container 1000. Lid 20 includes multiple components, including lid base 100, handle 200, cap 300, moveable arm 400, biasing member 500, vent sealing member 600, actuator 700, and lid sealing member 800.

Lid base 100 may be formed of food-grade plastic (e.g., polypropylene, copolyester, the copolymer sold as Eastman Tritan, high-density polyethylene (HDPE), polyoxymethylene (POM), or acrylonitrile butadiene styrene (ABS)), glass, or metal (e.g., steel, stainless steel, aluminum, copper, or titanium), and may be formed as a single, unitary piece.

As shown, for example, in FIG. 8, lid base 100 includes dividing wall 120. The illustrated dividing wall 120 curves upward toward the front of the lid base 100 to partially define spout 102. Spout 102 is located near the edge of lid base 100—offset from a center of lid base 100—so that it is in a comfortable location for a user when the user is drinking from the spout. As shown, drinking passageway 104 extends through spout 102.

A top end of straw 900 may fit together with a lower portion 136 of drinking passageway 104, which may be cylindrical or tapered (e.g., by interference fit around an exterior of lower portion 136 or within an interior of lower portion 136). Straw 900 may be formed of food-grade plastic (e.g., polypropylene, copolyester, the copolymer sold as Eastman Tritan, high-density polyethylene (HDPE), polyoxymethylene (POM), or acrylonitrile butadiene styrene (ABS)), glass, or metal (e.g., steel, stainless steel, aluminum, copper, or titanium).

Lid base 100 includes lower side wall 118 extending downward from a lower side of dividing wall 120. Together, lower side wall 118 and dividing wall 120 define a lower volume 132 of lid base 100. When lid 20 is assembled with container 1000, lower volume 132 is in fluid communication with interior 1006 of container 1000. Lid base 100 also includes an upper side wall 122 that extends upward from an upper side of dividing wall 120. Upper side wall 122 may be formed of multiple wall segments and interruptions and may help to obscure internal features of lid 20 from view when lid 20 is assembled. Together, upper side wall 122 and dividing wall 120 define an upper volume 134 of lid base 100.

Lid base 100 may include vent opening 106. Vent opening 106 extends through dividing wall 120 and opens into lower volume 132 and upper volume 134. Vent opening 106 allows for fluid communication between lower volume 132 and upper volume 134 when vent opening 106 is open (i.e., when not sealed, for example by sealing member 600). Vent opening 106 may have a circular shape, as shown, for example, in FIG. 4, or vent opening 106 may have other shapes, such as a stadium or rectangular shape. In some embodiments, a vent protrusion 138 surrounds vent opening 106.

When lid 20 is in a sealed configuration, for example, as shown in FIG. 8, vent opening 106 is not open. Rather, it is sealed by vent sealing member 600. Vent sealing member 600 is positioned above vent opening 106 and may be located on and move along with moveable arm 400. For example, as shown in FIG. 8, moveable arm 400 may define a channel 404 into which vent sealing member 600 is received and retained. In some embodiments, vent sealing member 600 is a gasket; in other embodiments, vent sealing member 600 may be integrally formed as part of moveable arm 400 or lid base 100. Vent sealing member 600 may be formed of a food-grade material suitable to create a seal between lid base 100 and moveable arm 400. The term seal as used here and elsewhere in this document does not necessarily require a perfect hermetic seal; rather a seal capable of maintaining a pressure differential is sufficient.

In some embodiments, vent sealing member 600 may seal vent opening 106 by pressing against dividing wall 120 through which vent opening 106 extends. In some embodiments, for example, as shown in FIG. 8, vent sealing member 600 may seal vent opening 106 by pressing against vent protrusion 408. Vent protrusion 408 may form a continuously raised edge of smaller diameter than an outer diameter of vent sealing member 600, which may allow for a tighter seal by providing vent sealing member 600 with more room to deform without interference from dividing wall 120.

The illustrated dividing wall 120 in FIG. 8 defines a recess 112 sized, shaped, and positioned to receive moveable arm 400 therein. Recess 112 may be defined by a recess floor 116 and recess walls 117 (see, e.g., FIG. 7) extending vertically from recess floor 116. Recess walls 117 may include first receiving portions 126 (shown in phantom lines) on sides of recess 112. Moveable arm 400 may include corresponding engaging portions 406 (see, e.g., FIGS. 5 and 6). As shown, for example, in FIG. 7, engaging portions 406 of moveable arm 400 may be received into receiving portions 126 of recess 112. When moveable arm 400 is received into recess 112 in this way, moveable arm 400 may pivot about an axis 40 (see, e.g., FIG. 8) through engaging portions 406. For example, moveable arm 400 may pivot from the sealed position, in which vent opening 106 is sealed (as shown, for example in FIG. 8) to the venting position, in which vent opening 106 is not sealed (as shown, for example, in FIGS. 10 and 12 and to be discussed in greater detail below). In some embodiments, moveable arm 400 may not be positioned in a recess and/or may move in a different manner. For example, moveable arm may move translationally up and down and/or left and right.

When moveable arm 400 is in a sealed position, as shown, for example, in FIG. 8, there may be a gap 114 between a bottom surface of moveable arm 400 and floor 116 of recess 112. Gap 114 provides moveable arm 400 with free space to move into when moveable arm 400 moves from the sealed position (as shown, for example in FIG. 8) to the venting position (as shown, for example, in FIGS. 10 and 12 and to be discussed in greater detail below). The location of gap 114 relative to moveable arm 400 may change depending on the nature of the movement of moveable arm 400. For example, in an embodiment in which moveable arm 400 moves from side to side, gap 114 may be provided on the sides of moveable arm 400.

In some embodiments, moveable arm 400 be moved (e.g., pivoted) by applying a force to a portion of moveable arm 400. For example, as can be seen, for example, in FIG. 8, application of a downward force to a rear portion of movable arm 400 (relative to axis 40) may move movable arm 400 in a first rotational direction toward the sealed position, while application of an upward force to a rear portion of moveable arm 400 (relative to axis 40) may move movable arm in a second rotational direction away from the sealed position. Application of a downward force to a front portion of moveable arm 400 (relative to axis 40) may move moveable arm 400 in the second rotational direction away from the sealed position, while application of an upward force to a front portion of moveable arm 400 (relative to axis 40) may move moveable arm 400 in the first rotational direction toward the sealed position.

In some embodiments, lid base 100 includes biasing member 500 to bias movable arm 400 toward the sealed position. Biasing member 500 may bias moveable arm 400, for example, by applying a downward force to a rear portion of moveable arm 400 (relative to axis 40), by applying an upward force to a front portion of moveable arm 400 (relative to axis 40), or by applying both a downward force to a rear portion of moveable arm 400 and an upward force to a front portion of moveable arm 400. Biasing member may be, for example, a torsion spring (as shown in FIG. 7), a compression spring, or any elastic material.

The illustrated biasing member 500 (shown, for example, in FIG. 7) is a torsion spring. Torsion spring 500 includes loop-shaped portion 502, first arm 504, and second arm 506. First arm 504 of torsion spring 500 extends in a first direction generally toward the rear of lid base 100, and second arm 506 of biasing member 500 extends in a second direction generally toward the front of lid base 100. A portion of first arm 504 may be positioned in a notch 410 provided in moveable arm 400, and a portion of second arm 506 may contact recess floor 116 of lid base 100. Loop-shaped portion 502 may be positioned around engaging portion 406 of moveable arm 400.

In some embodiments, a user may apply a force to a portion of moveable arm 400 to move (e.g., pivot) moveable arm 400. Generally, the force applied by a user may overcome the biasing force of biasing member 500 if a biasing member 500 is provided. In some embodiments, a user may apply a force to a portion of moveable arm 400 indirectly. For example, as shown in FIGS. 8 and 10, and discussed in more detail below, moving actuator 700 from the first position (shown, for example, in FIG. 8) to the second position (shown, for example, in FIG. 10) may cause movable arm 400 to move from the sealed position (shown, for example, in FIG. 8) to the venting position (shown, for example, in FIG. 10).

As mentioned previously, lid 20 may include cap 300 moveable between a closed position and an open position. When cap 300 is in the closed position, for example, as shown in FIG. 8, cap 300 may extend across and close upper volume 134 of lid base 100. Cap 300 may be formed of food-grade plastic (e.g., polypropylene, copolyester, the copolymer sold as Eastman Tritan, high-density polyethylene (HDPE), polyoxymethylene (POM), or acrylonitrile butadiene styrene (ABS)), glass, or metal (e.g., steel, stainless steel, aluminum, copper, or titanium), and may be formed as a single, unitary piece.

Cap 300 may include sealing member 302 to seal drinking passageway 104. When cap 300 is in the closed position, for example, as shown in FIG. 8, sealing member 302 of cap 300 may extend down into spout 102 and press against an inner surface of spout 102 to create a seal. Sealing member 302 may be a plug or gasket. Sealing member 302 may be attached (e.g., permanently or removably attached) to a portion (e.g., a post) of cap 300, or may be integrally formed as part of cap 300 or spout 102.

Cap 300 may be moveable between the closed position and the open position by, for example, pivoting, sliding, or lifting. As illustrated in FIG. 7, for example, upper side wall 122 of lid base 100 may include second receiving portions 128, and cap 300 may include engaging portions 304 corresponding to second receiving portions 128. Engaging portions 304 of cap 300 may be received into second receiving portions 128, thereby enabling cap 300 to pivot about an axis 50 through the engaging portions 304 of cap 300. Similarly, as illustrated in FIG. 7, for example, upper side wall 122 of lid base 100 may include third receiving portions 130, and handle 200 may include engaging portions 202 corresponding to third receiving portions 130. Engaging portions 202 of handle 200 may be received into third receiving portions 130, thereby enabling handle 200 to pivot about an axis 60 through the engaging portions 202 of handle 200. In some embodiments, axis 40 (the axis of rotation of moveable arm 400), axis 50 (the axis of rotation of cap 300), and axis 60 (the axis of rotation of handle 200) may all be parallel. However, in other embodiments, the axes may not be parallel.

As mentioned previously, when lid 20 is assembled with container 1000, container 1000 is sealed relative to an exterior of drinking vessel 10 when lid 20 is in a sealed configuration. For example, in the sealed configuration shown in FIG. 8, lid sealing member 800 creates a seal between lid 20 and container 1000, vent sealing member 600 seals vent opening 106, and sealing member 302 of cap 300 seals drinking passageway 104. Accordingly, in this configuration, interior 1006 of container 1000 and lower volume 132 of lid base 100 are sealed relative to an atmosphere outside of drinking vessel 10. If lid 20 is maintained in this sealed configuration for a sufficient period of time, a pressure difference can develop between interior 1006/lower volume 132 and an atmosphere outside of drinking vessel 10. The pressure difference may be caused, for example, by a hot beverage within container 1000 or a change in elevation.

In the sealed configuration shown, for example, in FIG. 8, upper volume 134 of lid base 100 may be in fluid communication with an atmosphere outside drinking vessel 10. For example, lid base 100 may include opening 108 in upper side wall 122. In some embodiments, actuator 700 positioned in opening 108 may include channel 710. As a result, air may enter (or exit) upper volume 134 of lid base 100, even when lid 20 is in a sealed configuration.

In FIGS. 10 and 11, actuator 700 has been moved from the first position to the second position (e.g., by pushing button 702 toward the front of drinking vessel 10). The section view of FIGS. 10 and 11 is taken vertically at the position of line X-X′ of FIG. 3 offset to the right of the center of lid 20. As illustrated, for example, in FIG. 10, when a force (represented by arrow 70 in FIGS. 10 and 11) is applied to actuator 700 in a direction generally toward the front of vessel 10, a surface 714 of actuator 700 moves toward and engages a surface 412 of moveable arm 400. As actuator surface 714 moves further toward moveable arm surface 412, the surfaces interact such that moveable arm 400 moves away from the sealed position (shown, for example in FIG. 8) toward the venting position (shown, for example, in FIG. 10). For example, as illustrated in FIG. 10, actuator surface 714 and moveable arm surface 412 are ramped such that when actuator surface 714 contacts moveable arm surface 412, the surfaces slide against each other, causing moveable arm surface 412 to move upward and toward the front of lid 20. As a result, moveable arm 400 moves away from the sealed position (pivoting about axis 40). While actuator surface 714 and moveable arm surface 412 are ramped in the illustrated embodiments, one or both of these surfaces can be not ramped in some embodiments.

Vent sealing member 600 moves along with moveable arm 400 such that vent sealing member 600 is moved off of vent opening 106 and no longer seals vent opening 106. In this position, interior 1006 of container 1000 and lower volume 132 of lid base 100 are in fluid communication with upper volume 134 of lid base and an atmosphere outside drinking vessel 10. For example, air (represented by arrow 80 in FIGS. 10 and 11) may flow through dividing wall 120 to an atmosphere outside drinking vessel 10.

For example, air may flow from interior 1006 of container 1000, through lower volume 132 of lid base 100, through vent opening 106, through upper volume 134, and through opening 108 in upper side wall 122 of lid base 100 (or through channel 710 of actuator 700).

In FIGS. 12-13, cap 300 has been moved from a closed position to an open position (e.g., by rotating cap 300 about axis 50 in a first rotational direction from the position shown in FIGS. 7-11). The section in FIGS. 12 and 13 is taken vertically at the position of line X-X′ of FIG. 3 offset to the right of the center of lid 20. In FIG. 12, cap 300 has pivoted more than 90 degrees between the closed position and the open position. However, cap 300 may be configured to rotate more or less than shown in the figures. For example, cap may be configured to rotate 90 degrees or 180 degrees. In some embodiments, upper side wall 122 of lid base 100 may include stops (e.g., bumps 140) to inhibit movement of cap 300 beyond a maximum position. For example, as shown in FIG. 4, as cap 300 is pivoted in a first rotational direction (i.e., in a direction toward the open position), bump 140 on upper side wall 122 eventually abuts wall 308 of cap 300 and inhibits cap 300 from rotating more. Alternatively or additionally, wall 308 of cap 300 may include bumps 310 to inhibit movement of cap 300 beyond a maximum position. For example, as shown in FIG. 4, when cap 300 is pivoted in the first rotational direction, bump 310 on cap 300 abuts upper side wall 122 of lid base 100 and inhibits cap 300 from rotating more. Preventing movement of cap 300 beyond a maximum position may be desirable, for example, in order for cap 300 to maintain engagement with moveable arm 400 (discussed in more detail below) or to obscure internal features of lid 20 from view.

As illustrated, for example, in FIG. 12, actuator 700 may have a curved upper surface 720 to permit cap 300 to easily rotate past actuator 700. Moveable arm 400 may have a first portion 414 on one side of axis 40 and a second portion 416 on the opposite side of axis 40. The first portion 414 of moveable arm 400 may be sized, shaped, and positioned such that when cap 300 pivots about axis 50, cap 300 does not engage the first portion 414. The second portion 416 of moveable arm 400 may be sized, shaped, and positioned such that when cap 300 pivots about axis 50, cap 300 engages the second portion 416.

For example, as shown in FIG. 12, first portion 414 of moveable arm 400 and second portion 416 may define a concave upper profile (curved or angled). When cap 300 is pivoted about axis 50 (e.g., in a first rotational direction toward the open position), cap 300 may rotate past first portion 414 without contacting it. As cap 300 continues to be pivoted about axis 50 in the same rotational direction, cap 300 may contact second portion 416, thereby applying a force on the second portion of moveable arm 400. In some embodiments (for example, as shown in FIG. 12) first portion 414 of moveable arm 400 may be curved and have a radius of curvature that is no less than the distance between axis 50 and an outer surface of the rear portion of cap wall 308, and second portion 416 of moveable arm may also be curved but have a radius of curvature that is less than the distance between axis 50 and an outer surface of the rear portion of cap wall 308. When cap 300 is pivoted about axis 50 (e.g., in a first rotational direction toward the open position), the outer surface of the rear portion of cap wall 308 does not engage the first portion 414 of moveable arm 400 but does engage the second portion 416 of moveable arm 400, thereby applying a downward force on the second portion 416 of moveable arm 400. As a result, moveable arm 400 pivots about axis 40 and moves away from the sealed position. Vent sealing member 600 moves along with moveable arm 400 such that vent sealing member is moved off of vent opening 106 and no longer seals vent opening 106. When cap 300 is pivoted to the open position, sealing member 302 of cap 300 may also be removed from spout 102, thereby unsealing drinking passageway 104.

In this configuration, drinking passageway 104 and vent opening 106 are both unsealed. As a result, interior 1006 of container 1000 and lower volume 132 of lid base 100 are in fluid communication with upper volume 134 of lid base and an atmosphere outside drinking vessel 10. Air may flow, for example, from an atmosphere outside drinking vessel 10 to interior 1006 of container 1000, or vice versa.

For example, air may flow through opening 108 in upper side wall 122 of lid base 100 (or through channel 710 of actuator 700), through vent opening 106, and into interior 1006 of container 1000.

Allowing air to enter container 1000 makes it easier for a user to suck through straw 900. This is because air is able to move through vent opening 106 to take the place of liquid that has been displaced through drinking passageway 104, helping keep a steady flow of liquid through drinking passageway 104 and minimizing vacuum buildup that could interrupt the flow.

In some embodiments, for example, as illustrated in FIG. 12, a portion of cap 300 remains engaged with moveable arm 400 while cap 300 is in the open position, thereby holding moveable arm 400 in the venting position. As mentioned previously, bumps 140 may cooperate with wall 308 of cap 300 and/or bumps 310 may cooperate with upper side wall 122 of lid base 100 to inhibit cap 300 from rotating beyond a maximum position and to maintain engagement between a portion of cap 300 and moveable arm 400. As a result, moveable arm 400 remains in the venting position such that vent sealing member 600 does not seal vent opening 106 while cap 300 is in the open position. In this way, interior 1006 of container 1000 remains in fluid communication with an atmosphere outside container 1000 through vent opening 106. As a result, a user will more easily be able to suck through a straw, as discussed above.

In some embodiments, when a user moves cap 300 from the open position to the closed position, vent sealing member 600 automatically seals vent opening 106 in response. This automatic sealing may be achieved, for example, by use of biasing member 500. For example, as can be appreciated with reference to FIG. 12, when cap 300 rotates back to the closed position, cap 300 will no longer apply a downward force to second portion 416 of moveable arm 400. However, biasing member 500 will apply a downward force to first portion 414 of moveable arm 400. Accordingly, moveable arm 400 will pivot about axis 40 and move toward the sealed position. Vent sealing member 600 will move along with moveable arm 400 and therefore back to sealing vent opening 106.

As discussed previously, a user may sometimes want container 1000 to stay sealed. For example, a user may want container 1000 to stay sealed so that a beverage being carried inside container 1000 will not leak on a user or a user's belongings when drinking vessel 10 is placed in the user's backpack or other bag (where drinking vessel 10 may encounter forces from other items in the user's bag, or may change orientation). In such a situation (as in others), a user may be able to place vessel 10 in a locked configuration in which actuator 700 is prevented from moving to the second position. This locked configuration is shown in FIGS. 14-16 and described in more detail below.

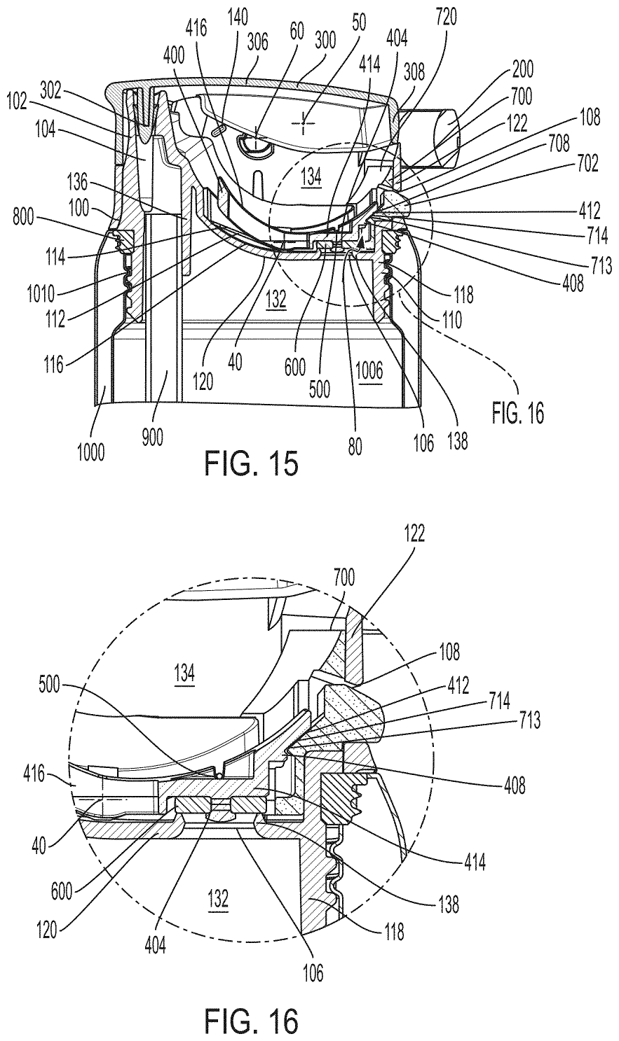

In FIGS. 14-16, actuator 700 has been moved from an unlocked position to a locked position (e.g., by rotating actuator 700 counter-clockwise relative to moveable arm 400 and lid base 100 from the position shown in FIGS. 7-11). The section in FIG. 14 is taken horizontally at the position of line VII-VII′ of FIG. 3 offset from the top of lid 20. The section in FIGS. 15 and 16 is taken vertically at the position of line VIII-VIII′ of FIG. 3 offset to the left of the center of lid 20.

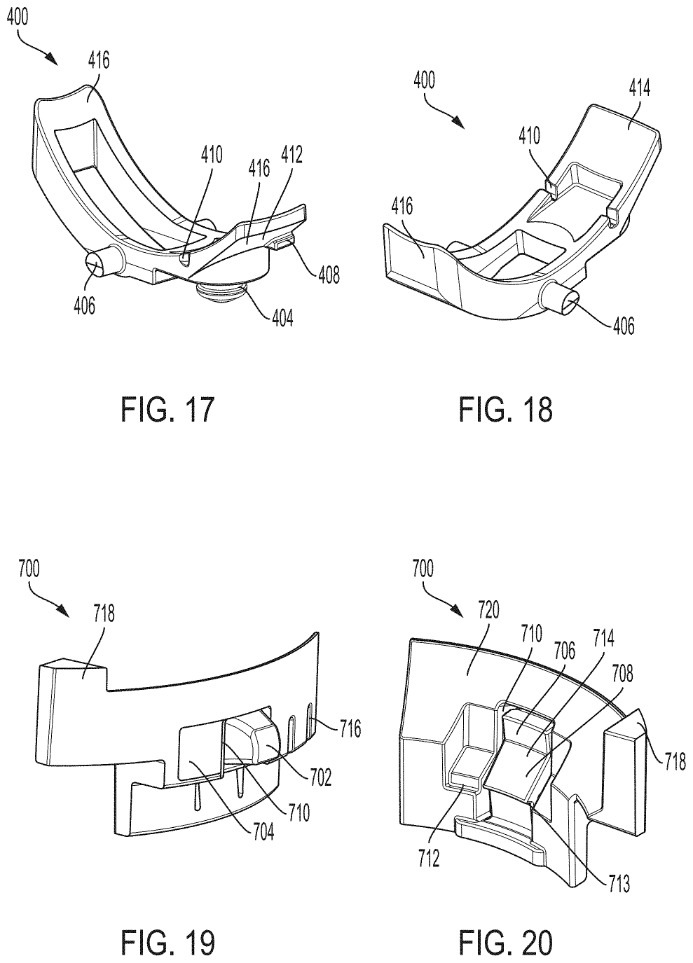

As shown, for example, in FIG. 5, moveable arm 400 may have a protrusion 408 on a lower portion of one side. To help show features of movable arm 400, FIGS. 17 and 18 show movable arm 400 larger and in isolation. For example, protrusion 408 shown in FIGS. 5 and 17 is on a lower portion of the left side of moveable arm 400. As shown, for example, in FIG. 6, actuator 700 may have a recess 706. To help show features of actuator 700, FIGS. 19 and 20 show actuator 700 larger and in isolation. A floor 708 of recess 706 may be formed of multiple floor segments and interruptions. Floor 708 may partially define a depression 712 on one side of recess 706. For example, in FIGS. 6 and 20, depression 712 is on the left side of recess 706. Depression 712 is sized, shaped, and positioned to receive protrusion 408 of moveable arm 400 when lid 20 is in an unlocked configuration. Floor 708 may also partially define a ledge 713 below a portion of floor 708. For example, in FIGS. 6 and 20, ledge 713 is in the center of recess 706. Ledge 713 is sized, shaped, and positioned to receive protrusion 408 of moveable arm 400 when lid 20 is in a locked configuration.

When lid 20 is in the locked configuration, for example, as shown in FIGS. 14-16, protrusion 408 is received by ledge 713. When a force is applied to button 702 in a direction generally toward the front of vessel 10, protrusion 408 interferes with ledge 713, thereby inhibiting actuator 700 from moving to the second position and inhibiting moveable arm 400 from moving to the venting position. Similarly, when a force is applied to moveable arm 400 through vent opening 106 (e.g., because of pressure buildup inside container 1000), protrusion 408 interferes with ledge 713, thereby inhibiting moveable arm 400 from moving to the venting position. In these ways, vent opening 106 is less likely to become accidently unsealed during use when lid 20 is in a locked configuration.

When lid 20 is in the unlocked configuration, for example, as shown in FIGS. 6-8, protrusion 408 is received in depression 712. When a force is applied to button 702 in a direction generally toward the front of vessel 10, protrusion 408 generally does not interfere with ledge 713. Accordingly, actuator 700 can be moved from the first position to the second position.

Lid 20 can be moved from the unlocked configuration to the locked configuration by moving actuator 700 relative to moveable arm 400. A user may move actuator 700 to the locked position, for example, by engaging a portion of actuator 700 and sliding actuator 700 (e.g., in a counter-clockwise direction about a central axis 30 of lid 20, viewed from the top of lid 20). In some embodiments, a user may engage button 702 to move actuator 700 to or from the locked position. In other embodiments, a user may engage a separate part of actuator 700 to move actuator 700 to or from the locked position.

In some embodiments, actuator 700 includes stop 718 to inhibit movement of cap 300 from the closed position to the open position. Inhibiting movement of cap 300 to the open position may be desirable, for example, so that a user vents or is reminded to vent container 1000 through vent opening 106 (rather than drinking passageway 104) prior to unsealing drinking passageway 104. This avoids or reduces the likelihood of pressure being relieved through drinking passageway 104.

Inhibiting movement of cap 300 into the open position may also be desirable so that a user may carry drinking vessel 10 in a bag with other items without worrying about cap 300 coming open and spilling the contents of container 1000. As shown, for example, in FIG. 5, stop 718 may protrude upwardly from an upper portion of actuator 700. As shown, for example, in FIG. 7, upper side wall 122 of lid base 100 may include void 144 sized, shaped, and positioned to receive stop 718. Actuator 700 may be moved relative to lid base 100 so that when actuator 700 is in the unlocked position (for example, as shown in FIG. 7), stop 718 is positioned in void 144. When actuator 700 is in this position, cap 300 may move through upper volume 134 and into the open position. However, when actuator 700 is in the locked position (for example, as shown in FIG. 14) stop 718 is positioned at least partially outside void 144 below a portion of cap wall 308. In this way, if a user tries to open cap 300, cap wall 308 will abut stop 718, thereby inhibiting continued opening.

As illustrated and described above, when in the locked position actuator 700 inhibits movement of both cap 300 and movable arm 400, and allows such movement when in the unlocked position. However, these features need not be dependent. In some embodiments actuator 700 may be moved between the locked position and the unlocked position to inhibit or allow movement of movable arm 400 but may have no effect on movement of cap 300. In some embodiments actuator 700 may be moved between the locked position and the unlocked position to inhibit or allow movement of cap 300 but may have no effect on movement of movable arm 400. In some embodiments, actuator 700 may have more than one locked position, such that in a first locked position actuator 700 may inhibit movement of movable arm 400 but not cap 300, and in a second locked position actuator 700 may inhibit movement of cap 300 but not movable arm 400.

It is to be appreciated that the Detailed Description section, and not the Summary and Abstract sections, is intended to be used to interpret the claims. The Summary and Abstract sections may set forth one or more but not all exemplary embodiments of the disclosed invention(s) as contemplated by the inventor(s), and thus, are not intended to limit the disclosed invention(s) and the appended claims in any way.

The foregoing description of the specific embodiments will so fully reveal the general nature of the claimed invention that others can, by applying knowledge within the skill of the art, readily modify and/or adapt for various applications such specific embodiments, without undue experimentation, without departing from the general concept of the claimed invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the claimed invention should not be limited by any of the above-described exemplary embodiments, but should be defined only in accordance with the claims and their equivalents.

What is claimed is:

1. A lid for a drinking vessel, the lid comprising:
a lid base defining a vent opening therethrough;
a movable arm coupled to the lid base; and
an actuator accessible from an exterior of the lid base,
wherein the movable arm is movable between a sealed position, in which the vent opening is sealed, and a venting position, in which the vent opening is not sealed,
wherein the movable arm is biased toward the sealed position,
wherein the actuator is movable between a first position and a second position, and
wherein the movable arm moves from the sealed position to the venting position in response to the actuator moving from the first position to the second position.

2. The lid of claim 1, wherein the actuator is biased toward the first position, and
wherein the movable arm automatically moves from the venting position to the sealed position in response to the actuator moving from the second position to the first position.

3. The lid of claim 1, wherein the movable arm defines a first surface,
wherein the actuator defines a second surface, and
wherein when the actuator moves from the first position to the second position, the second surface engages the first surface, causing the first surface and a sealing portion of the movable arm to move in a direction away from the vent opening, thereby unsealing the vent opening.

4. The lid of claim 3, wherein at least one of the first surface or the second surface is ramped, and
wherein the second surface engages the first surface by sliding against it.

5. The lid of claim 3, wherein the movable arm pivots about an axis to move between the sealed position and the venting position, and
wherein the first surface and the sealing portion of the movable arm are both located on the same side of the movable arm relative to the axis.

6. The lid of claim 1, wherein the actuator is movable between a locked position, in which the actuator is inhibited from moving to the second position, and an unlocked position, in which the actuator is not inhibited from moving to the second position.

7. The lid of claim 6, wherein in the locked position the actuator inhibits movement of the movable arm away from the sealed position.

8. The lid of claim 1, further comprising a cap movable between a closed position and an open position,
wherein the movable arm is movable between the sealed position and the venting position by pivoting about an axis,
wherein the movable arm has a first portion extending on a first side of the axis,
wherein the movable arm has a second portion extending on a second side of the axis, and
wherein when the cap moves from the closed position to the open position, a portion of the cap engages the second portion of the movable arm, causing the movable arm to pivot into the venting position.

9. The lid of claim 8, wherein in the open position the cap holds the movable arm in the venting position.

10. The lid of claim 1, further comprising:
a drinking spout defining a drinking passageway through the lid base;
a cap movable between a closed position, in which the drinking passageway is sealed, and an open position, in which the drinking passageway is not sealed; and
a straw extending away from the lid base in fluid communication with the drinking passageway.

11. The lid of claim 10, wherein the drinking passageway and the vent opening are the only openings through the lid base configured to open to an interior space of a container when the lid is attached to the container.

12. A drinking vessel comprising:
the lid of claim 10; and
a container, wherein the lid is configured to attach to the container to close an interior space of the container,
wherein, when the lid is attached to the container, the straw extends into the interior space of the container.

13. A lid for a drinking vessel, the lid comprising:
a lid base defining a vent opening therethrough;
a vent sealing member movably coupled to the lid base and movable between a sealed position, in which the vent sealing member seals the vent opening, and a venting position, in which the vent sealing member does not seal the vent opening; and
a cap coupled to the lid base and movable between a closed position and an open position,
wherein, in response to the cap moving from the closed position to the open position, the vent sealing member moves from the sealed position to the venting position, and
wherein the cap is movable relative to the vent sealing member.

14. The lid of claim 13, wherein the vent sealing member is maintained in the venting position while the cap is in the open position, and wherein the vent sealing member moves to the sealed position in response to the cap moving from the open position to the closed position.

15. The lid of claim 13, wherein the vent sealing member is biased toward the sealed position.

16. The lid of claim 13, further comprising a movable arm pivotably coupled to the lid base about an axis,
wherein the vent sealing member is coupled to the movable arm, and
wherein when the cap moves from the closed position to the open position, a portion of the cap engages the movable arm and causes the movable arm to pivot about the axis, thereby moving the vent sealing member from the sealed position to the venting position.

17. The lid of claim 16, wherein the movable arm has a first portion extending on a first side of the axis,
wherein the movable arm has a second portion extending on a second side of the axis,
wherein the vent sealing member is coupled to the first portion of the movable arm, and
wherein when the cap moves from the closed position to the open position, the portion of the cap engages the second portion of the movable arm.

18. The lid of claim 16, wherein the portion of the cap remains engaged with the movable arm while the cap is in the open position, thereby maintaining the vent sealing member in the venting position while the cap is in the open position.

19. The lid of claim 16, wherein, to move the cap between the open position and the closed position, the cap pivots about a second axis.

20. The lid of claim 19, further comprising a drinking spout defining a drinking passageway through the lid base,
wherein, in the closed position, a sealing portion of the cap seals the drinking passageway, and
wherein the sealing portion of the cap is disposed on an opposite side of the cap as the portion of the cap that engages the movable arm, relative to the second axis.

21. The lid of claim 13, further comprising:
a drinking spout defining a drinking passageway through the lid base, wherein, in the closed position, a sealing portion of the cap seals the drinking passageway; and
a straw extending away from the lid base in fluid communication with the drinking passageway.

22. The lid of claim 21, wherein the drinking passageway and the vent opening are the only openings through the lid base configured to open to an interior space of a container when the lid is attached to the container.

23. A drinking vessel comprising:
the lid of claim 21; and
a container, wherein the lid is configured to attach to the container to close an interior space of the container,
wherein, when the lid is attached to the container, the straw extends into the interior space of the container.

24. A method for venting a drinking vessel, comprising:
pivoting a movable arm disposed within a lid for a drinking vessel in a first rotational direction about an axis, wherein pivoting the movable arm in the first rotational direction causes a vent opening of the lid to be unsealed; and
pivoting the movable arm in a second rotational direction about the axis, wherein pivoting the movable arm in the second rotational direction causes the vent opening of the lid to be sealed,
wherein the movable arm is biased in the second rotational direction.

25. The method of claim 24, wherein pivoting the movable arm in the first rotational direction comprises applying a force to the movable arm, and
wherein pivoting the movable arm in the second rotational direction occurs automatically upon removal of the force from the movable arm.

26. The method of claim 25, wherein applying the force comprises pressing a button accessible from an exterior of the drinking vessel.

27. The method of claim 25, wherein applying the force comprises opening a cap of the drinking vessel.

28. A method for venting a drinking vessel, comprising:
moving an actuator accessible from an exterior of a lid base from a first position to a second position, wherein moving the actuator from the first position to the second position causes a vent opening of the lid base to be unsealed; and
moving the actuator from the second position to the first position, wherein moving the actuator from the second position to the first position causes the vent opening of the lid base to be sealed,
wherein a drinking passageway of the lid base remains sealed while the vent opening is unsealed.

29. The method of claim 28, wherein the vent opening is positioned under a cap of the lid, and
wherein the cap seals the drinking passageway when the cap is in a closed position.
